(19) United States
(12) Patent Application Publication
(10) Pub. No.: US 2005/0169509 A1
(43) Pub. Date: Aug. 4, 2005

(54) Method for improving the image quality

(76) Inventors: Ingmar Grasslin, Bonningstedt (DE); Tobias Schaffter, Hamburg (DE)

Correspondence Address: Thomas M Lundin;Philips Intellectual Property & Standards, 595 Miner Road, Cleveland, OH, 44143, US

(21) Appl. No.: 10/513,528

(22) PCT Filed: Apr. 29, 2003
(86) PCT No.: PCT/IB03/01665

(30) Foreign Application Priority Data
May 7, 2002 (DE) 102 20 295.8

(51) Int. Cl. G06K 9/00

(52) U.S. Cl. 382/130

(57) ABSTRACT

The invention relates to a method for the processing of a series of raw images (1), notably for coronary MR or CT angiography. A reference image (3) is selected from the series of raw images (1) is found by matching a selected image region of interest within the reference image (3) with individual raw images from the series of raw images (1). The reference image (3) and the image (4) which is similar to the reference image are then processed so as to form an image of improved image quality (8). In order to obtain images which are as faithful and sharp as possible, the invention proposes to form the image of improved image quality (8) by weighted averaging of the intensity values of corresponding pixels within the reference image (3) and the image (4) which is similar to the reference image.

The invention relates to a method of processing a series of raw images, notably for coronary MR or CT angiography, which method includes the following steps:
a) selecting a reference image from the series of raw images;
b) selecting at least one image region of interest within the selected reference image;
c) finding at least one image which is similar to the reference image by matching the selected image region of interest with individual raw images from the series of raw images;
d) processing the reference image and the image which is similar to the reference image so as to form an image of improved image quality.

The invention also relates to a computer program for carrying out such a method, the computer program receiving input in the form of a series of raw images and generating an image of improved image quality therefrom, and also to a system for image acquisition and processing in conformity with the method, notably an MR apparatus or CT apparatus, which system includes means for the acquisition of a series of raw images of an object, means for processing the series of raw images so as to form one or more images of improved image quality, and means for displaying the series of raw images and the images of improved image quality.

A method of the kind set forth is known, for example, from U.S. Pat. No. 6,088,488. The cited document concerns the diagnostic imaging of coronary blood vessels. Special problems are encountered in MR and CT angiography, that is, problems which are due to the complex motions of the beating heart and respiratory motions which are superposed on the cardiac motion. In MR or CT imaging it is common practice to select a slice within the examination zone so as to define the image plane. Said motions on the one hand are the reason why the position of the structures of interest within the image plane changes periodically. On the other hand, the fact must be taken into account that the structures move periodically out of and into the image plane again. For MR and CT real-time imaging of the heart a series of raw images is acquired in rapid succession in order to enable the examination of the coronary vessels in the various phases of motion of the beating myocardium. In order to obtain images that are suitable for diagnostic purposes, image-processing techniques must be applied so as to compensate the motions occurring and to correct the motional artifacts caused thereby. To this end, the cited United States patent proposes to select from the series of raw images first a reference image, which shows the structures to be examined. Next an image region of interest is selected by a user. This image region of interest contains, for example, a given coronary vessel. Subsequently, a correlation technique is applied so as to find a plurality of images from the series of raw images, which are similar to the reference image. To this end, the raw images of the series are individually matched with the image region of interest of the reference image as selected by the user. The raw images found are subjected to motion correction, which compensates motion-induced shifts of the structures of interest within the image region of interest. Subsequently, an image of improved image quality is generated in that the pixel intensity values of the reference image and of the motion-corrected raw images are averaged.

It is a drawback of the known image processing method that the image artifacts caused by the complex motions of the heart are compensated to an inadequate extent only. The contraction of the myocardium during the cardiac motion causes shifts, rotations and distortions of the structures to be imaged; in the case of the known method the foregoing causes said structures to be displayed in a blurred fashion and with a poor definition of detail in some parts.

Therefore, it is an object of the invention to provide an improved image processing method which produces clear and faithfully detailed images of moving structures.

This object is achieved on the basis of a method of the kind set forth in that in the step d) of the method the image of improved image quality is formed by weighted averaging of the intensity values of corresponding pixels within the reference image and the image which is similar to the reference image, each pixel of the image which is similar to the reference image being assigned a weighting factor which varies in dependence on the difference between the intensity values to be averaged.

The invention is based on the idea that the image artifacts caused by motion, notably blurring produced during the averaging of the raw images, can be compensated by performing weighted averaging of the reference image and the image which is similar to the reference image. As a result, not only the image noise is suppressed but the image sharpness is improved at the same time. In accordance with the method of the invention, each pixel of the image, which is similar to the reference image is assigned a weighting factor whereby the intensity value of the pixel is multiplied during the averaging operation. The weighting factor varies from one pixel to another and advantageously assumes a small value in the case of a large difference between the intensity values of corresponding pixels of the reference image and the image which is similar to the reference image whereas it assumes a large value when correspondence exists between the intensity values. In the border case, which does not occur in practice and in which no motion-dependent intensity differences exist between the raw images of the acquired series, averaging is performed with a constant, maximum weighting factor in the step d) of the method, so that exclusively the image noise is reduced.

Related techniques for motion-compensated weighted averaging are known as AWA filters (“Adaptive Weighted Averaging”) which are used in the field of video techniques (see Özkan et al. in IEEE Transactions on Circuits and Systems for Video Technology, Vol. 3, No. 4, pp. 277 to 290, 1993). The present invention transfers the AWA filter technique to the field of diagnostic imaging of moving structures, effective suppression of motion artifacts being achieved when in the step c) of the method the raw images to be averaged from the series of raw images are determined on the basis of correspondence with the selected reference image before the AWA filter is applied. In conformity with the method of the invention, the correspondence can be advantageously recognized automatically by means of known correlation techniques as customarily used, for example, for a plurality of applications in the field of pattern recognition. The method in accordance with the invention can thus be referred to as an AWCA filter (Adaptive Weighted Correlated Averaging) because, unlike in the known AWA technique, raw images are filtered which do not directly succeed one another in the series.

In conformity with an advantageous further version of the method in accordance with the invention the image which is similar to the reference image is subjected to motion correction prior to the processing in the step d) of the method. For optimum compensation of motional artifacts, not only a translation correction can be applied but also a rotation correction and a distortion correction. Known methods operating with a sub-pixel accuracy are particularly suitable for MR and CT imaging. Also feasible are advanced techniques of motion estimation which derive parameters for complex motion models from the differences existing between the images. It is important in this respect that the image region of interest of the reference image as selected in the step d) of the method is made to match the relevant raw image from the series, thus ensuring that the structures of interest are imaged with an optimum sharpness and with as little noise as possible.

The method in accordance with the invention is equally suitable for 2D imaging and 3D imaging. In the latter case the series of raw images is a series of three-dimensional raw image data sets.

A particularly advantageous further version of the method of the invention is obtained when in the step b) of the method at least two image regions of interest are selected within the selected reference image, when in the step c) of the method each time at least one image which is similar to the reference image is found for each image region of interest by matching each of the selected image regions with individual raw images from the series of raw images, when furthermore in the step d) of the method each time an image of improved image quality is formed for each of the images similar to the reference image by weighted averaging, and in when in a step e) of the method the images of improved image quality formed in the step d) of the method are combined so as to form an image of high image quality. According to this approach a plurality of image regions of interest are taken into account independently of one another. For each selected image region there is formed a separately averaged image of improved image quality, that is, by way of the described weighted averaging. These images are then combined so as to form an image of high image quality. To this end, for example, parts of the images of improved image quality are combined, in conformity with the image regions selected each time, so as to form the image of high image quality and the region situated outside the image regions of interest is supplemented by averaging the reference image with individual ones of the images similar to the reference image. Overall an improved motion correction can thus be achieved and the resultant overall image quality is enhanced further, because a plurality of local image regions is matched independently of one another.

A computer program which is suitable for carrying out the method in accordance with the invention receives a series of raw images as input and forms an image of improved image quality therefrom in conformity with the following processing steps:
a) selection of at least one reference image from the series of raw images by a user;
b) interactive selection of at least one image region of interest within the selected reference image by the user;
c) automatic finding of at least one image which is similar to the reference image by matching the selected image region of interest with individual raw images from the series of raw images;
d) automatic processing of the reference image and the image which is similar to the reference image so as to form the image of improved image quality, the image of improved image quality being formed in the processing step d) by weighted averaging of the intensity values of corresponding pixels within the reference image and the image which is similar to the reference image, each pixel of the image which is similar to the reference image being assigned a weighting factor which varies in dependence on the difference between the intensity values to be averaged. The software required for implementing this computer program, for example, on MR or CT apparatus, can be advantageously made available to the users on a suitable data carrier, such as a disc or a CD-ROM, or by downloading via a data network (the Internet). The user intervenes in the method in accordance with the invention in the processing steps a) and b) by first selecting a relevant reference image and by subsequently selecting at least one image region of interest within this image.

When the processing steps c) and d) in the computer program in accordance with the invention are repeated for a plurality of images which are similar to the reference image and stem from the series of raw images, the images of improved image quality each time formed being combined successively so as to form an ultimate image, the user can interactively monitor the image processing in that the ultimate image is displayed after each repetition of the processing steps c) and d), so that the user can evaluate the image quality and the image contents of the ultimate image and interrupt the processing when the user considers the image quality to be adequate. Alternatively, the image quality can also be automatically evaluated, for example, by determination of the mean signal-to-noise ratio, and the image processing can be controlled by specifying suitable interruption criteria. Moreover, the user has the possibility of interactively changing the image regions of interest if the structures that can be recognized in the ultimate image being formed necessitate a new selection. This is the case, for example, when in MR or CT angiography the images appearing during the interactively monitored image processing reveal stenoses which are situated outside the originally selected image regions.

A system for image acquisition and processing in conformity with the method of the invention includes means for the acquisition of a series of raw images of an object, means for processing the series of raw images so as to form one or more images of improved image quality, and means for displaying the series of raw images and the images of improved image quality, the means for processing the series of raw images comprising program control whereby the following processing steps can be carrier out:
a) selection of a reference image from the series of raw images by a user of the system;
b) interactive selection of at least one image region of interest within the selected reference image by the user;
c) automatic finding of at least one image which is similar to the reference image by matching the selected image region of interest with individual raw images from the series of raw images;
d) automatic processing of the reference image and the image which is similar to the reference image so as to form the image of improved image quality.

The program control produces the image of improved image quality in the processing step d) by weighted averaging of the intensity values of corresponding pixels within the reference image and the image which is similar to the reference image, each pixel of the image which is similar to the reference image being assigned a weighting factor which varies in dependence on the difference between the intensity values to be averaged. The method in accordance with the invention can thus be advantageously carried out by means of conventional diagnostic apparatus in clinical use, for example, MR or CT apparatus. To this end it is merely necessary to adapt the program control accordingly. Particularly fast image processing can be achieved when the means for processing the series of raw images comprise a plurality of processing units operating in parallel, so that the user can select at least two image regions of interest within the selected reference image in the processing step b), when furthermore in the processing step c) the program control automatically finds each time at least one image which is similar to the reference image for each image region of interest by matching each of the selected image regions with individual raw images from the series of raw images by means of a processing unit, by generating in the processing step d) for each of the images which are similar to the reference image a respective image of improved image quality by the weighted averaging by means of a respective processing unit, and when in a processing step e) the images of improved image quality formed in the processing step d) are combined so as to form an image of high image quality which is displayed on the display means. For the fast parallel processing of the mutually independent image regions, therefore, a plurality of processing units are used, for example, suitable digital signal processors (DSPs).

Embodiments of the invention will be described in detail hereinafter with reference to the Figures. Therein:

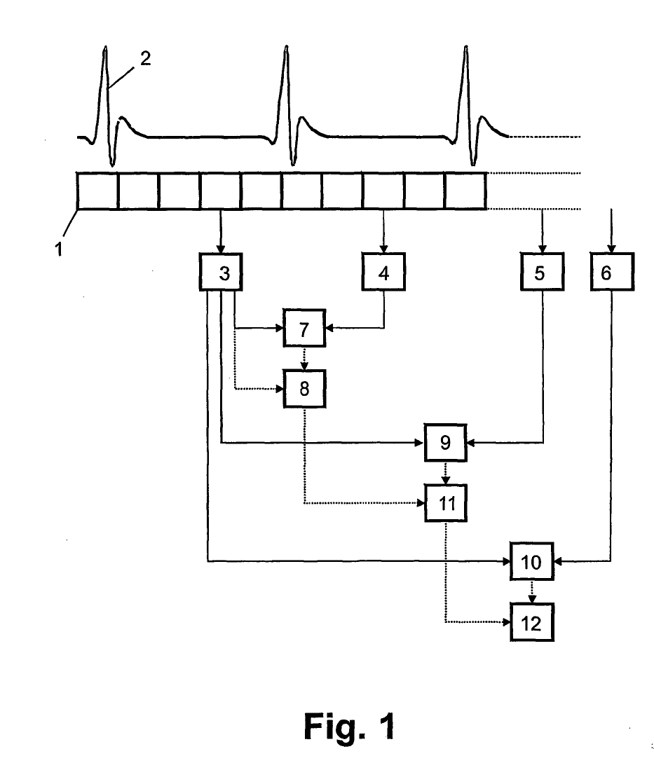

FIG. 1 is a diagrammatic representation of the image processing in accordance with the invention;

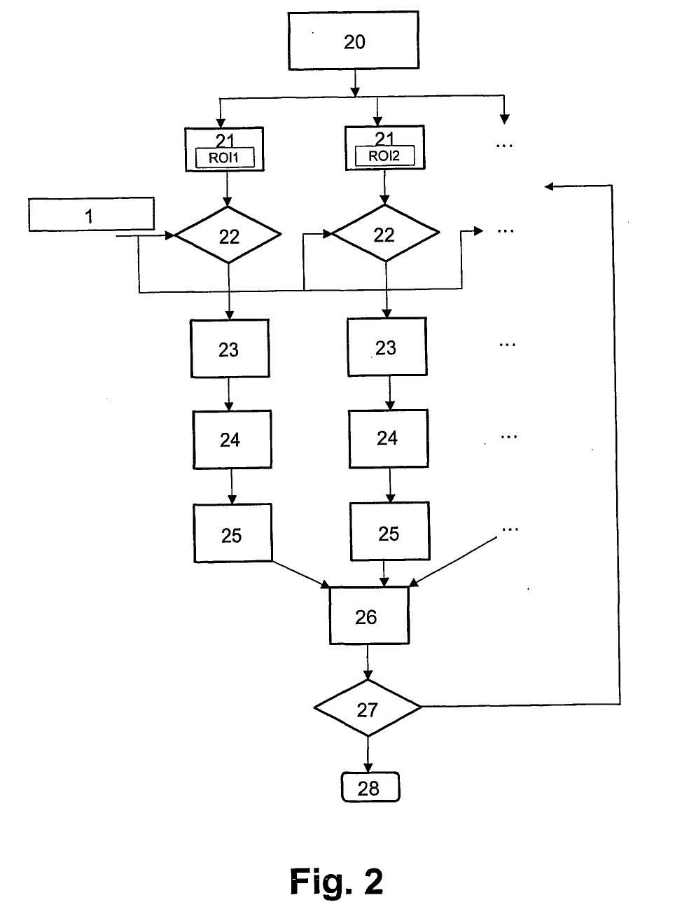

FIG. 2 shows a flow chart of the method in accordance with the invention with parallel processing of a plurality of image regions of interest; and

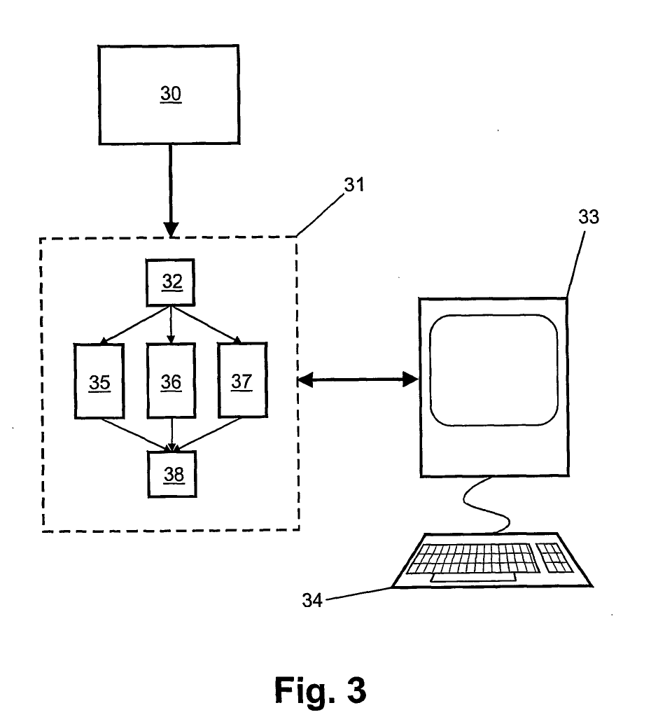

FIG. 3 shows a block diagram of an image processing system in accordance with the invention.

FIG. 1 is a diagrammatic representation of a series of raw images 1, which are produced, for example, by MR or CT angiography. An ECG trace 2 which is shown above the series of raw images 1 shows that approximately five individual images are acquired for each heat beat. The user of the MR or CT apparatus selects from the series of raw images 1 a reference image 3 because this image shows, for example, the heart in a given cardiac phase in which the coronary vessels to be examined are very well visible in the selected image plane. Next the user selects at least one image region of interest (not shown) from the reference image 3. During the next step of the method a plurality of images 4, 5 and 6 which are similar to the reference image 3 are derived from the series of raw images 1 by matching the selected image region of interest with each individual raw image of the series of raw images. Generally known correlation techniques are suitable for this purpose. The raw images 4, 5 and 6 thus contain the rendition of the coronary vessels to be examined because of their matching with the reference image 3 and can be processed, together with the reference image 3, so as to form an image of improved image quality. To this end, first the raw image 4 is subjected to a motion correction (translation, rotation and possibly distortion correction) (not shown) in order to compensate notably the respiratory motion which is not synchronous with the heartbeat. Subsequently, a weighting image 7 is formed from the reference image 3 and the raw image 4, which weighting image contains the intensity values of the motion-corrected raw image 4 multiplied by a weighting factor which varies in dependence on the difference between the intensity values of corresponding pixels of the reference image 3 and the motion-corrected raw image 4. The weighting factor assumes a small value if the intensity values of corresponding pixels of the reference image 3 and the raw image 4 which is similar to the reference image deviate strongly whereas it assumes a large value when correspondence exists between the intensity values. An image of improved image quality 8 is formed from the weighting image 7 by simple averaging with the reference image 3. The same is done for the remaining raw images 5 and 6. Weighting images 9 and 10 are generated in the described manner, after which first an image 11 of improved image quality is formed from the image 8 together with the weighting image 9 by averaging, and ultimately an image of even better image quality 12 is generated therefrom in conjunction with the weighting image 10. It appears from FIG. 1 that the method in accordance with the invention can be continued for further raw images of the series 1, the image quality of the image obtained thus being continuously enhanced. For each averaging operation use is made of the respective last image of improved image quality, be it that the weighting images are calculated each time on the basis of the reference image first selected. It is thus ensured that the image sharpness is optimized, because blurring of the imaged structures due to averaging is avoided in accordance with the invention.

The flow chart shown in FIG. 2 commences with a step 20 in which the reference image is selected. Next a plurality of image regions of interest (ROI1, ROI2, . . . ) is selected in a step 21. Separate processing takes place for each of the image regions ROI1, ROI2. The finding of images similar to the reference image is performed in a step 22 in which the relevant image region ROI1, ROI2 is matched with individual raw images from the series of raw images 1. In a step 23 a motion correction is performed on the raw images found, said correction being based on the relevant image region and in a step 24 weighting images are formed from the reference image and the motion-corrected raw images in the described manner. In a step 25 the weighting images and the reference image are processed to form images of improved image quality by averaging, which images are ultimately combined so as to form an image of high image quality in a step 26. In a step 27 the quality of this image is evaluated, after which either the processing is continued by finding further raw images which are similar to the reference image in the step 22, or the processing is terminated in a step 28. FIG. 2 clearly shows that in accordance with the invention parallel processing can be carried out for a plurality of image regions of interest.

FIG. 3 shows a system in accordance with the invention for image acquisition and image processing in accordance with the invention. It consists of means 30 for the acquisition of a series of raw images of an object, which is not shown in the Figure. The means 30 are, for example, the image acquisition means of an MR or CT apparatus. The raw images acquired are applied to program-controlled means 31 for further processing. Such means are, for example, a microcomputer as customarily used in MR or CT apparatus for image processing. The means 31 include an image buffer 32 in which the raw images of the series are temporarily stored. The individual raw images can then be displayed on display means 33 of the system, so that a user can select one of the raw images as the reference image on a control unit 34. The user can then interactively select a plurality of image regions of interest within said reference image. The means 31 also include several processing units 35, 36 and 37 which may be, for example, suitable DSPs which operate in parallel and automatically find, independently of one another, at least one image which is similar to the reference image for each of the image regions of interest, that is, by matching each of the selected image regions with individual raw images from the series of raw images. An image of improved image quality is then produced by the weighting in accordance with the invention by means of one of the processing units 35, 36 and 37. An averaging unit 38 is provided so as to combine these images into an image of high image quality. The image of high image quality can then be displayed on the display means 33.

1. A method of processing a series of raw images, notably for coronary MR or CT angiography, which method includes the following steps:
a) selecting a reference image from the series of raw images;
b) selecting at least one image region of interest within the selected reference image;
c) finding at least one image which is similar to the reference image by matching the selected image region of interest with individual raw images from the series of raw images;
d) processing the reference image and the image which is similar to the reference image so as to form an image of improved image quality, wherein in the step d) of the method the image of improved image quality is formed by weighted averaging of the intensity values of corresponding pixels within the reference image and the image which is similar to the reference image, each pixel of the image which is similar to the reference image being assigned a weighting factor which varies in dependence on the difference between the intensity values to be averaged.

2. A method as claimed in claim 1, wherein the image which is similar to the reference image is subjected to motion correction prior to the processing in the step d) of the method.

3. A method as claimed in claim 2, wherein the motion correction includes a translation correction and/or a rotation correction and/or a distortion correction.

4. A method as claimed in claim 1, wherein the series of raw images is a series of three-dimensional raw image data sets.

5. A method as claimed in claim 1, wherein in the step b) of the method at least two image regions of interest are selected within the selected reference image, that in the step c) of the method each time at least one image which is similar to the reference image is found for each image region of interest by matching each of the selected image regions with individual raw images from the series of raw images, that in the step d) of the method each time an image of improved image quality is formed for each image similar to the reference image by the weighted averaging, and that in a step e) of the method the images of improved image quality formed in the step d) of the method are combined so as to form an image of high image quality.

6. A computer readable media comprising a computer program for carrying out the method claimed in claim 1, which computer program receives a series of raw images as input and forms an image of improved image quality therefrom in conformity with the following processing steps:
a) selection of at least one reference image from the series of raw images by a user;
b) interactive selection of at least one image region of interest within the selected reference image by the user;
c) automatic finding of at least one image which is similar to the reference image by matching the selected image region of interest with individual raw images from the series of raw images;
d) automatic processing of the reference image and the image which is similar to the reference image so as to form the image of improved image quality, wherein in the processing step d) the image of improved image quality is formed by weighted averaging of the intensity values of corresponding pixels within the reference image and the image which is similar to the reference image, each pixel of the image which is similar to the reference image being assigned a weighting factor which varies in dependence on the difference between the intensity values to be averaged.

7. A computer readable media as claimed in claim 6, wherein the processing steps c) and d) are repeated for a plurality of images which are similar to the reference image and stem from the series of raw images, the images of improved image quality thus formed each time being combined successively so as to form an ultimate image.

8. A computer readable media as claimed in claim 7, wherein the ultimate image is displayed after each repetition of the processing steps c) and d), so that the user can evaluate the image quality and the image contents of the ultimate image and change the selection of the image regions of interest accordingly or interrupt the processing if the user evaluates the image quality as being adequate.

9. A system for image acquisition and processing in conformity with the method as claimed in claim 1 notably an MR or CT apparatus, comprising means for the acquisition of a series of raw images of an object, means for processing the series of raw images so as to form one or more images of improved image quality, and means for displaying the series of raw images and the images of improved image quality, the means for processing the series of raw images comprising program control whereby the following processing steps can be carried out:
a) selection of a reference image from the series of raw images by a user of the system;
b) interactive selection of at least one image region of interest within the selected reference image by the user;
c) automatic finding of at least one image which is similar to the reference image by matching the selected image region of interest with individual raw images from the series of raw images;
d) automatic processing of the reference image and the image which is similar to the reference image so as to form the image of improved image quality, wherein the program control generates the image of improved image quality in the step d) by weighted averaging of the intensity values of corresponding pixels within the reference image and the image which is similar to the reference image, each pixel of the image which is similar to the reference image being assigned a weighting factor which varies in dependence on the difference between the intensity values to be averaged.

10. A system as claimed in claim 9, wherein
the means for processing the series of raw images comprise a plurality of processing units which operate in parallel; and
that the user can select at least two image regions of interest within the selected reference image in the processing step b);
that in the processing step c) the program control automatically finds each time at least one image similar to the reference image for each image region of interest by matching each of the selected image regions with individual raw images from the series of raw images by means of a processing unit;
that in the processing step d) for each of the images which are similar to the reference image an image of improved image quality is generated by the weighted averaging by means of a respective processing unit; and
that in a processing step e) the images of improved image quality formed in the processing step d) are combined so as to form an image of high image quality which is displayed on the display means.
